(19) United States
(12) Patent Application Publication
(10) Pub. No.: US 2017/0329022 A1
(43) Pub. Date: Nov. 16, 2017

(54) SCINTILLATOR ASSEMBLY FOR USE IN CT IMAGING SYSTEMS

(71) Applicant: Morpho Detection, LLC, Newark, CA (US)

(72) Inventor: Brian Lee Bures, Pelham, NH (US)

(21) Appl. No.: 15/151,170

(22) Filed: May 10, 2016

(51) Int. Cl. G01T 1/20; C09K 11/77; C09K 11/68; C09K 11/61

(52) U.S. Cl. CPC G01T 1/2018; C09K 11/7719; C09K 11/616; C09K 11/68; C09K 11/7701

(57) ABSTRACT

A scintillator assembly for use in a CT imaging system is provided. The scintillator assembly includes a frame including a base, and a plurality of walls extending substantially perpendicular from the base, wherein the base and the plurality of walls define a plurality of pixel compartments, and granular scintillating material contained in at least some of the plurality of pixel compartments, wherein the granular scintillating material is configured to convert x-ray beams into light.

### BACKGROUND

The embodiments described herein relate generally to CT imaging systems, and more particularly, to scintillator assemblies for CT imaging systems.

In some computed tomography (CT) imaging systems, an x-ray source projects a fan-shaped beam which is collimated to lie within an X-Y plane of a Cartesian coordinate system and generally referred to as an “imaging plane”. The x-ray beam passes through an object being imaged. The beam, after being attenuated by the object, impinges upon an array of radiation detectors. The intensity of the attenuated radiation beam received at the detector array is dependent upon the attenuation of the x-ray beam by the object. Each detector element of the array produces a separate electrical signal that is a measurement of the beam intensity at each detector location. The intensity measurements from all the detectors are acquired separately to produce a transmission profile and reconstruct an image of the object.

Detector assemblies for at least some known CT imaging systems include a scintillator having a plurality of pixels. Each pixel may be a crystal or ceramic pixel that is surrounded by a reflecting material. These pixels may be crystalline or polycrystalline, and may be fabricated using cutting and polishing techniques. These techniques are relatively expensive and time-consuming to implement, and generate pixels that are generally only able to be used in a scintillator with matching dimensions.

### BRIEF SUMMARY

In one aspect, a scintillator assembly for use in a CT imaging system is provided. The scintillator assembly includes a frame including a base, and a plurality of walls extending substantially perpendicular from the base, wherein the base and the plurality of walls define a plurality of pixel compartments, and granular scintillating material contained in at least some of the plurality of pixel compartments, wherein the granular scintillating material is configured to convert x-ray beams into light.

In another aspect, a frame for use in a scintillator assembly of a CT imaging system is provided. The frame includes a base, and a plurality of walls extending substantially perpendicular from the base, wherein the base and the plurality of walls define a plurality of pixel compartments, each pixel compartment of the plurality of pixel compartments configured to receive granular scintillating material that is configured to convert x-ray beams into light.

In yet another aspect, a method of assembling a scintillator assembly for use in a CT imaging system is provided. The scintillator assembly includes a frame that defines a plurality of pixel compartments. The method includes depositing granular scintillating material in at least some of the plurality of pixel compartments, the granular scintillating material configured to convert x-ray beams into light, and sealing the plurality of pixel compartments.

### BRIEF DESCRIPTION OF THE DRAWINGS

FIG. 1 is a perspective view of an exemplary CT imaging system.

FIG. 2 is a schematic diagram of the CT imaging system shown in FIG. 1.

FIG. 3 is a block diagram of an exemplary computing device that may be used with the CT imaging system shown in FIGS. 1-3.

FIG. 4 is a schematic diagram of an exemplary detector assembly that may be used with the CT imaging system shown in FIG. 1.

FIG. 5 is a perspective view of an exemplary frame that may be used to form the scintillator assembly shown in FIG. 4.

FIG. 6 is a schematic plan view of an alternative frame.

FIG. 7 is a schematic plan of an alternative frame.

FIG. 8 is a schematic plan of an alternative frame.

FIG. 9 is a schematic plan view of the frame shown in FIG. 5 with pixel compartments filled with granular scintillating material.

### DETAILED DESCRIPTION

The systems and methods described herein provide a scintillator assembly for use in a CT imaging system. The scintillator assembly includes a frame having a base and a plurality of walls that define a plurality of pixel compartments. Granular scintillating material is deposited in at least some of the plurality of pixel compartments, and the plurality of pixel compartments are sealed.

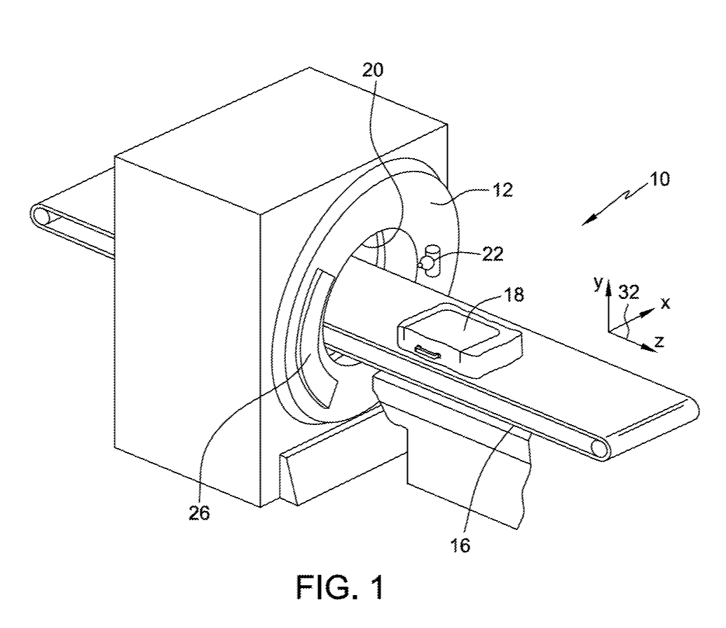

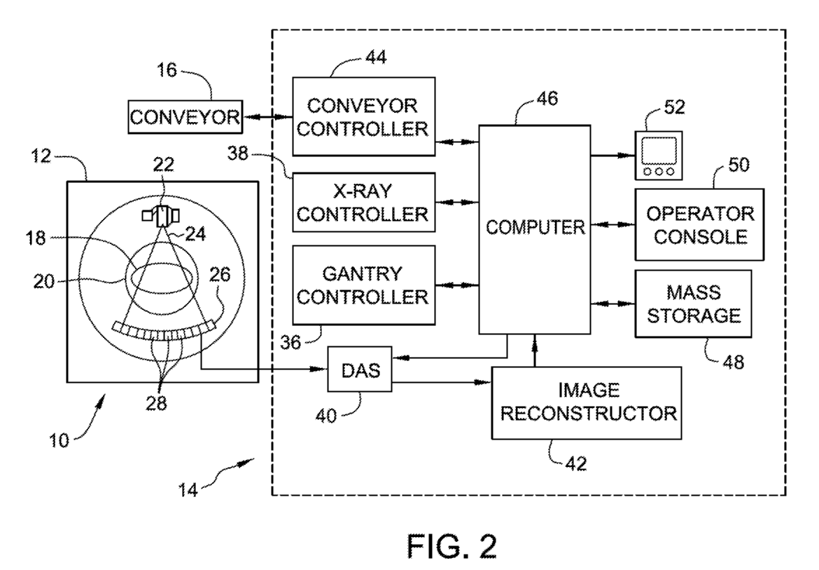

Referring now to FIGS. 1 and 2, a computed tomography (CT) imaging system 10 is shown. CT imaging system 10 is shown having a gantry 12, which is representative of a CT scanner, a control system 14, and a motorized conveyor belt 16 for positioning an object 18, such as a piece of luggage, in a gantry opening 20 defined through gantry 12. Gantry 12 includes an x-ray source 22 that projects a fan beam of x-rays 24 toward a detector array 26 on the opposite side of gantry 12. Detector array 26 is formed by detector elements 28, which are radiation detectors that each produce a signal having a magnitude that represents and is dependent on the intensity of the attenuated x-ray beam after it has passed through object 18 being imaged. During a helical scan that acquires x-ray projection data, gantry 12 along with the x-ray source 22 and detector array 26 rotate within an x-y plane and around object 18 about a center of rotation, while object 18 is moved through gantry 12 in a z-direction 32 perpendicular to the x-y plane of rotation. In the exemplary embodiment, detector array 26 includes a plurality of detector rings each having a plurality of detector elements 28, the detector rings having an angular configuration corresponding to x-ray source 22.

Gantry 12 and x-ray source 22 are controlled by control system 14, which includes a gantry controller 36, an x-ray controller 38, a data acquisition system (DAS) 40, an image reconstructor 42, a conveyor controller 44, a computer 46, a mass storage-system 48, an operator console 50, and a display device 52. Gantry controller 36 controls the rotational speed and position of gantry 12, while x-ray controller 38 provides power and timing signals to x-ray source 22, and data acquisition system 40 acquires analog data from detector elements 28 and converts the data to digital form for subsequent processing. Image reconstructor 42 receives the digitized x-ray data from data acquisition system 40 and performs an image reconstruction process that involves filtering the projection data using a helical reconstruction algorithm.

Computer 46 is in communication with the gantry controller 36, x-ray controller 38, and conveyor controller 44 whereby control signals are sent from computer 46 to controllers 36, 38, 44 and information is received from controllers 36, 38, 44 by computer 46. Computer 46 also provides commands and operational parameters to data acquisition system 40 and receives reconstructed image data from image reconstructor 42. The reconstructed image data is stored by computer 46 in mass storage system 48 for subsequent retrieval. An operator interfaces with computer 46 through operator console 50, which may include, for example, a keyboard and a graphical pointing device, and receives output, such as, for example, a reconstructed image, control settings and other information, on display device 52.

Communication between the various system elements of FIG. 2 is depicted by arrowhead lines, which illustrate a means for either signal communication or mechanical operation, depending on the system element involved. Communication amongst and between the various system elements may be obtained through a hardwired or a wireless arrangement. Computer 46 may be a standalone computer or a network computer and may include instructions in a variety of computer languages for use on a variety of computer platforms and under a variety of operating systems. Other examples of computer 46 include a system having a microprocessor, microcontroller or other equivalent processing device capable of executing commands of computer readable data or program for executing a control algorithm. In order to perform the prescribed functions and desired processing, as well as the computations therefore (e.g., the execution of filtered back projection, fourier analysis algorithm(s), the control processes prescribed herein, and the like), computer 46 may include, but not be limited to, a processor(s), memory, storage, register(s), timing, interrupt(s), communication interfaces, and input/output signal interfaces, as well as combinations including at least one of the foregoing. For example, computer 46 may include input signal filtering to enable accurate sampling and conversion or acquisitions of such signals from communications interfaces. As described above, exemplary embodiments can be implemented through computer-implemented processes and apparatuses for practicing those processes.

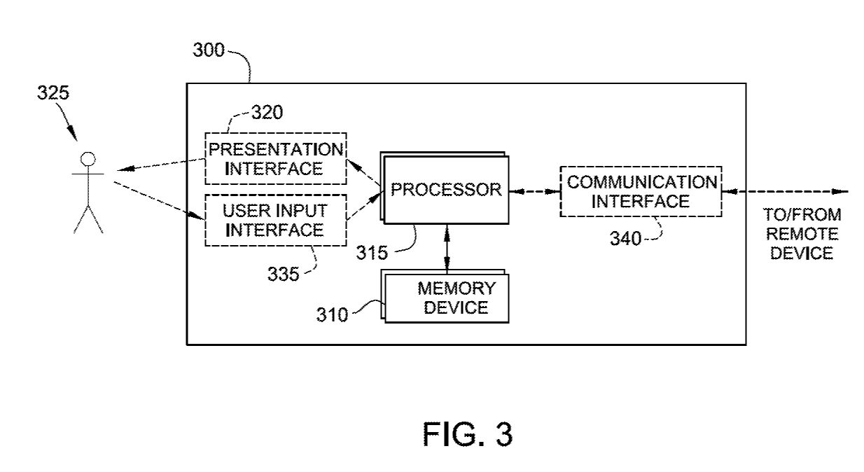

FIG. 3 is a block diagram of a computing device 300 that may be used to reconstruct an image of object 18, as described herein. Computing device 300 may be implemented as part of control system 14 or may be a separate computing device in communication with CT imaging system 10 or another imaging system. Computing device 300 includes at least one memory device 310 and a processor 315 that is coupled to memory device 310 for executing instructions. In some embodiments, executable instructions are stored in memory device 310. In the exemplary embodiment, computing device 300 performs one or more operations described herein by programming processor 315. For example, processor 315 may be programmed by encoding an operation as one or more executable instructions and by providing the executable instructions in memory device 310.

Processor 315 may include one or more processing units (e.g., in a multi-core configuration). Further, processor 315 may be implemented using one or more heterogeneous processor systems in which a main processor is present with secondary processors on a single chip. In another illustrative example, processor 315 may be a symmetric multi-processor system containing multiple processors of the same type. Further, processor 315 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), graphics processing units (GPU), and any other circuit capable of executing the functions described herein.

In the exemplary embodiment, memory device 310 is one or more devices that enable information such as executable instructions and/or other data to be stored and retrieved. Memory device 310 may include one or more computer readable media, such as, without limitation, dynamic random access memory (DRAM), static random access memory (SRAM), a solid state disk, and/or a hard disk. Memory device 310 may be configured to store, without limitation, application source code, application object code, source code portions of interest, object code portions of interest, configuration data, execution events and/or any other type of data. Further, reference templates may be stored on memory device 310.

In the exemplary embodiment, computing device 300 includes a presentation interface 320 that is coupled to processor 315. Presentation interface 320 presents information to a user 325. For example, presentation interface 320 may include a display adapter (not shown) that may be coupled to a display device, such as a cathode ray tube (CRT), a liquid crystal display (LCD), an organic LED (OLED) display, and/or an “electronic ink” display. In some embodiments, presentation interface 320 includes one or more display devices.

In the exemplary embodiment, computing device 300 includes a user input interface 335. User input interface 335 is coupled to processor 315 and receives input from user 325. User input interface 335 may include, for example, a keyboard, a pointing device, a mouse, a stylus, a touch sensitive panel (e.g., a touch pad or a touch screen), a gyroscope, an accelerometer, a position detector, and/or an audio user input interface. A single component, such as a touch screen, may function as both a display device of presentation interface 320 and user input interface 335.

Computing device 300, in the exemplary embodiment, includes a communication interface 340 coupled to processor 315. Communication interface 340 communicates with one or more remote devices (e.g., in some embodiments, CT imaging system 10). To communicate with remote devices, communication interface 340 may include, for example, a wired network adapter, a wireless network adapter, and/or a mobile telecommunications adapter.

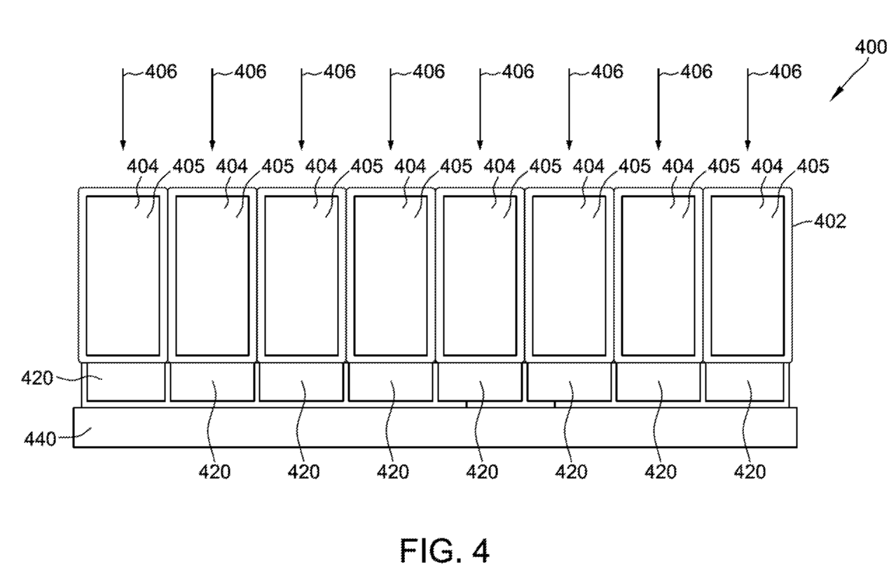

FIG. 4 is a schematic diagram of an exemplary detector assembly 400, such as detector array 26 (shown in FIG. 1) that may be used with CT imaging system 10 (shown in FIG. 1). Detector includes a scintillator assembly 402 that includes a plurality of pixels 404. For clarity, only eight pixels 404 are shown in FIG. 4. However, those of skill in the art will appreciate that scintillator assembly 402 will generally include a relatively large number of pixels 404. Further, although pixels 404 are shown forming a one-dimensional array in FIG. 4, those of skill in the art will appreciate that scintillator assembly 402 will generally include a two-dimensional array of pixels 404.

In the exemplary embodiment, each pixel 404 includes scintillating material 405. When an x-ray beam 406 (i.e., generated by x-ray source 22 (shown in FIG. 1)) strikes pixel 404, scintillating material 405 converts x-ray beam 406 into light. Scintillating material 405 in pixel 404 converts x-ray beam 406 into light 408 that is received at a corresponding photodiode 420. The number of photodiodes 420 corresponds to the number of pixels 404, such that each pixel 404 has an associated photodiode 420. Accordingly, as described above with respect to pixels 404, those of skill in the art will appreciate that detector assembly 400 will generally include a relatively large number of photodiodes 420 arranged in a two-dimensional array. In some embodiments, a light guide (not shown) may be coupled between scintillator assembly 402 and photodiodes 420 to guide light emitted from pixels 404 into photodiodes 420. Photodiodes 420 are coupled to a substrate 440 in the exemplary embodiment. Substrate 440 includes electrical connections (not shown) for relaying electrical signals from photodiodes 420 to control system 14 (shown in FIG. 2).

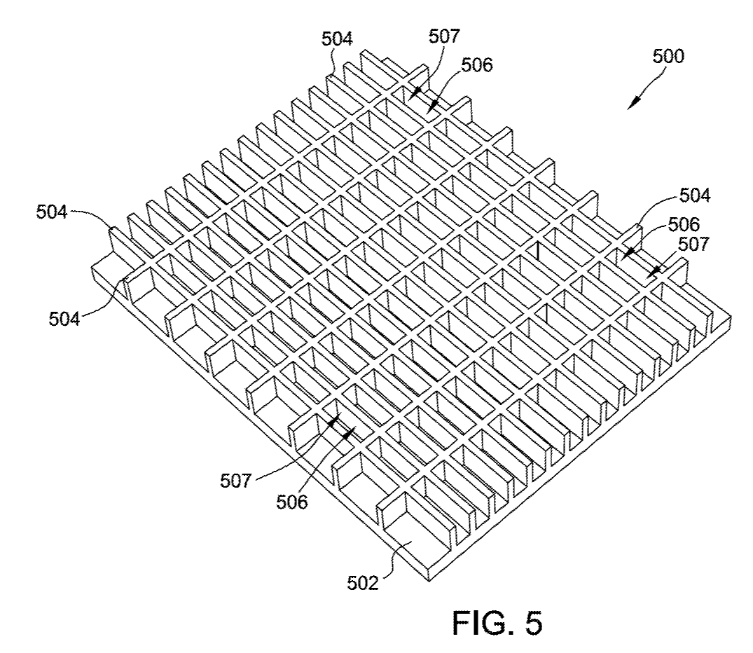

FIG. 5 is a perspective view of an exemplary frame 500 that may be used to form scintillator assembly 402 (shown in FIG. 4). Frame 500 includes a substantially planar base 502 that defines a plane, and a plurality of walls 504 that extend from base 502 in a direction substantially perpendicular to the plane. As shown in FIG. 5, base 502 and walls 504 define a plurality of pixel compartments 506, with each pixel compartment 506 having an open face 507 for depositing scintillating material, as described below. Frame 500 may be made of, for example, plastic, metal, ceramic, or another rigid material. In some embodiments, frame 500 is manufactured using three-dimensional (3D) printing techniques (i.e., additive manufacturing techniques). In embodiments where frame 300 is manufactured using metal 3D printing, a collimator may be directly integrated with frame 500.

In the embodiment shown in FIG. 5, each pixel compartment 506 is substantially cuboid. Alternatively, pixel compartments 506 may have any shape that enables frame 500 to function as described herein. For example, in some embodiments, pixel compartments 506 may have a cylindrical shape or a hexagonal prism shape. Further, in the embodiment shown in FIG. 5, frame 500 includes eighty-four pixel compartments 506 arranged in a two-dimensional regular grid. Alternatively, frame 500 may include any number and/or arrangement of pixel compartments 506 that enables frame 500 to function as described herein.

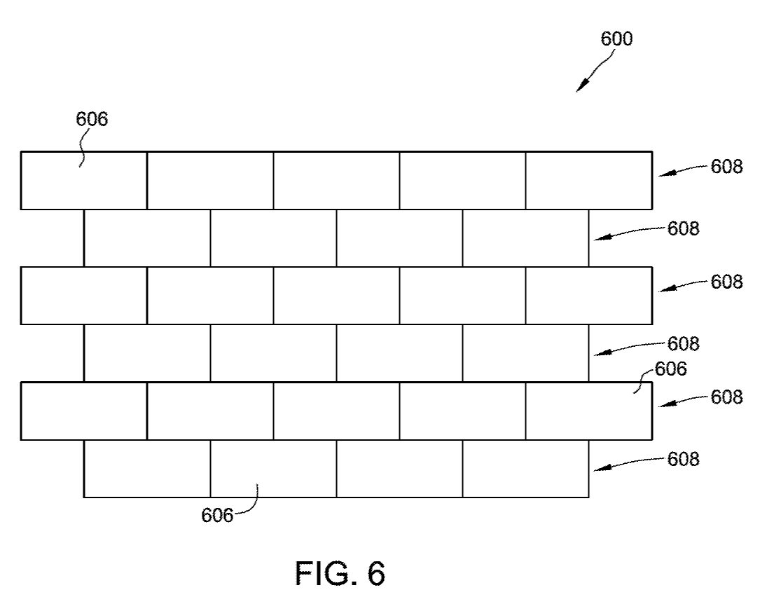

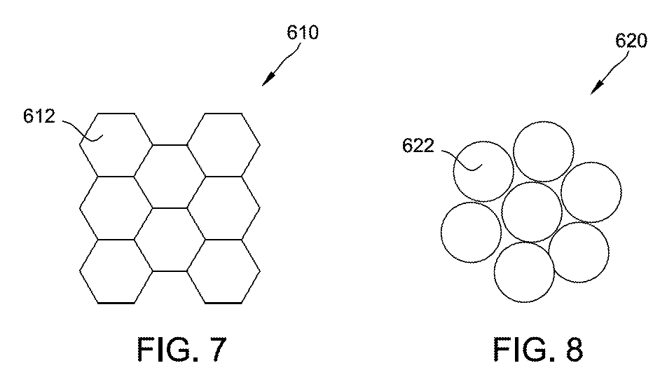

For example, FIG. 6 is a schematic plan view of an alternative frame 600. Like pixel compartments 506 (shown in FIG. 5), pixel compartments 606 in frame 600 are substantially cuboid. However, pixel compartments 606 are not arranged in a regular grid. Instead, alternating rows 608 of pixel compartments 606 are offset from one another to form a brick-like pattern of pixel compartments 606. Those of skill in the art will appreciate that many other variations in the number and arrangement of pixel compartments are within the scope of the disclosure. For example, FIG. 7 is a schematic plan of an alternative frame 610 that includes pixel compartments 612 that are substantially hexagonal prisms, and FIG. 8 is a schematic plan view of an alternative frame 620 that includes pixel compartments 622 that are substantially cylindrical.

Returning to FIG. 5, to form scintillator assembly 402, each pixel compartment 506 is filled with granular scintillating material. The granular scintillating material includes powder or grains of a scintillating material. The scintillating material may be discarded or excess material generated during polishing or cutting of a grown crystal of scintillating material. The scintillating material may also be new material (i.e., not discarded or excess material) that may be obtained relatively inexpensively in large volumes. The scintillating material may include, for example, Gadolinium OxySulfide (GOS), Sodium Iodide with dopants, Cesium Iodide with dopants, and/or Cadmium Tungstate.

In some embodiments, the granular scintillating material is bound, or coupled to frame 500. The granular scintillating material may be coupled to frame 500 using materials such as epoxy, organic adhesives, plastics, etc. Alternatively, the granular scintillating material may be coupled to frame 500 using local melting processes, such as laser sintering.

A depth of each pixel compartment 506 (i.e., a distance from base 502 to open face 507) may vary based on the specific scintillating material used and the application for scintillator assembly 402. For example, the depth of each pixel compartment 506 may range from approximately 2.0 to 6.0 millimeters (mm) in some embodiments. In some embodiments, the depth is approximately 4.0 mm.

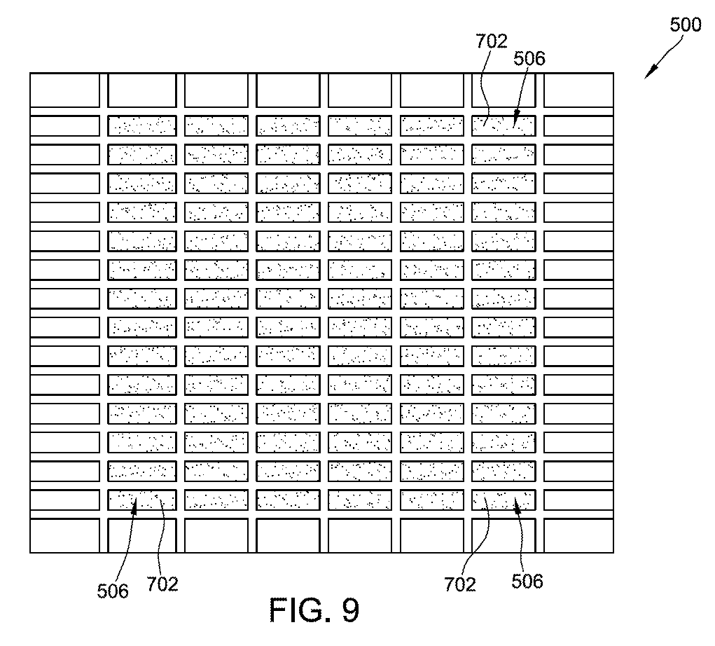

FIG. 9 is a schematic plan view of frame 500 with pixel compartments 506 filled with granular scintillating material 702. Granular scintillating material 702 may be dispensed into pixel compartments 506, for example, by hand or using suitable automated machinery. In the exemplary embodiment, each pixel compartment 506 is substantially completely filled with granular scintillating material 702 to facilitate ensuring proper operation of scintillator assembly 402.

To complete scintillator assembly 402 after dispensing granular scintillating material 702, open faces 507 are sealed. Each open face 507 may be sealed, for example, by coupling a diode or another optical device to frame 500 using a suitable adhesive (e.g., epoxy). Alternatively, open faces 507 may be sealed using any technique that enables from 500 to function as described herein.

Because a granular scintillating material is used, the same granular scintillating material may be used in different scintillating blocks having different dimensions and configurations. This is in contrast to at least some existing crystalline and polycrystalline pixels, which may only be used in scintillators with matching dimensions.

The embodiments described herein provide a scintillator assembly for use in a CT imaging system. The scintillator assembly includes a frame having a base and a plurality of walls that define a plurality of pixel compartments. Granular scintillating material is deposited in at least some of the plurality of pixel compartments, and the plurality of pixel compartments are sealed.

The systems and methods described herein may be used to detect contraband. As used herein, the term “contraband” refers to illegal substances, explosives, narcotics, weapons, special nuclear materials, dirty bombs, nuclear threat materials, a threat object, and/or any other material that a person is not allowed to possess in a restricted area, such as an airport. Contraband may be hidden within a subject (e.g., in a body cavity of a subject) and/or on a subject (e.g., under the clothing of a subject). Contraband may also include objects that can be carried in exempt or licensed quantities intended to be used outside of safe operational practices, such as the construction of dispersive radiation devices.

A computer, such as those described herein, includes at least one processor or processing unit and a system memory. The computer typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Exemplary embodiments of methods and systems are described above in detail. The methods and systems are not limited to the specific embodiments described herein, but rather, components of systems and/or steps of the methods may be used independently and separately from other components and/or steps described herein. Accordingly, the exemplary embodiment can be implemented and used in connection with many other applications not specifically described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A scintillator assembly for use in a CT imaging system, said scintillator assembly comprising:
a frame comprising:
a base that defines a plane; and
a plurality of walls extending from said base in a direction substantially perpendicular to the plane, wherein said base and said plurality of walls define a plurality of pixel compartments; and
granular scintillating material contained in a dry powder form in at least some of the plurality of pixel compartments, wherein said granular scintillating material is configured to convert x-ray beams into light.

2. A scintillator assembly in accordance with claim 1, wherein said base and said plurality of walls define a plurality of pixel compartments arranged in a regular grid.

3. A scintillator assembly in accordance with claim 1, wherein said base and said plurality of walls define a plurality of pixel compartments that are each one of substantially cuboid, substantially hexagonal prisms, and substantially cylindrical.

4. A scintillator assembly in accordance with claim 1, wherein said granular scintillating material comprises at least one of Gadolinium OxySulfide, Sodium Iodide with dopants, Cesium Iodide with dopants, and Cadmium Tungstate.

5. A scintillator assembly in accordance with claim 1, wherein said frame comprises at least one of plastic, metal, and ceramic.

6. A scintillator assembly in accordance with claim 1, wherein each of the plurality of pixel compartments has a depth of approximately 4.0 millimeters.

7. A scintillator assembly in accordance with claim 1, wherein said base and said plurality of walls define a plurality of pixel compartments arranged in a brick-like pattern.

8. A frame for use in a scintillator assembly of a CT imaging system, said frame comprising:
a base; and
a plurality of walls extending substantially perpendicular from said base, wherein said base and said plurality of walls define a plurality of pixel compartments, each pixel compartment of the plurality of pixel compartments including granular scintillating material in a dry powder form that is configured to convert x-ray beams into light, the plurality of pixel compartments arranged in a two-dimensional array in a brick-like pattern.

9. (canceled)

10. A frame in accordance with claim 8, wherein said base and said plurality of walls define a plurality of pixel compartments that are each one of substantially cuboid, substantially hexagonal prisms, and substantially cylindrical.

11. A frame in accordance with claim 8, wherein said frame comprises at least one of plastic, metal, and ceramic.

12. A frame in accordance with claim 8, wherein each of the plurality of pixel compartments has a depth in a range of approximately 2.0 millimeters to 6.0 millimeters.

13. A frame in accordance with claim 8, wherein the brick-like pattern includes adjacent rows of pixel compartments offset from one another.

14. A method of assembling a scintillator assembly for use in a CT imaging system, the scintillator assembly including a frame that defines a plurality of pixel compartments, the method comprising:
depositing granular scintillating material in a dry powder form in at least some of the plurality of pixel compartments, the granular scintillating material configured to convert x-ray beams into light; and
sealing the plurality of pixel compartments.

15. A method in accordance with claim 14, wherein sealing the plurality of pixel compartments comprises sealing the plurality of pixel compartments using epoxy.

16. A method in accordance with claim 14, wherein sealing the plurality of pixel compartments comprises coupling a plurality of optical devices to the frame.

17. A method in accordance with claim 16, wherein coupling a plurality of optical devices to the frame comprises coupling a plurality of photodiodes to the frame.

18. A method in accordance with claim 14, wherein depositing granular scintillating material comprises depositing granular scintillating material that includes at least one of Gadolinium OxySulfide, Sodium Iodide with dopants, Cesium Iodide with dopants, and Cadmium Tungstate.

19. A method in accordance with claim 14, wherein depositing granular scintillating material in at least some of the plurality of pixel compartments comprises depositing granular scintillating material in pixel compartments that are substantially cuboid.

20. A method in accordance with claim 14, wherein depositing granular scintillating material in at least some of the plurality of pixel compartments comprises depositing granular scintillating material in pixel compartments that are arranged in a regular grid.

21. A scintillator assembly in accordance with claim 1, wherein said scintillator assembly comprises the granular scintillating material contained in the dry powder for in at least some of the plurality of pixel compartments without a fluid.
